(19) United States
(12) Patent Application Publication
(10) Pub. No.: US 2011/0279357 A1
(43) Pub. Date: Nov. 17, 2011

(54) WIRELESS ACCESSIBLE DISPLAY AND METHODS

(76) Inventor: William Gary Leeks, Oro Valley, AZ (US)

(21) Appl. No.: 13/146,535

(22) PCT Filed: Jan. 27, 2010
(86) PCT No.: PCT/US10/22297

§ 371 Date: Jul. 27, 2011

Related U.S. Application Data
(60) Provisional application No. 61/157,778, filed on Mar. 5, 2009.
(60) Provisional application No. 61/148,045, filed on Jan. 28, 2009.
(60) Provisional application No. 61/110,566, filed on Jan. 28, 2009.

(51) Int. Cl. H04W 88/02; G09G 3/34; H04B 1/38

(52) U.S. Cl. 345/84; 455/73; 375/222

(57) ABSTRACT

Changeable displays are described and methods of making and using such displays are described as well. Displays can be made changeable using wireless communications, including through cellular indications networks. GSM modem technology can be used. A changeable display can incorporate a GSM modem incorporating a programmable SIM card, which may be programmed with a cellular telephone number for remotely accessing the display. An I/O unit may be included to interface between the modem and a visual display. An edge lit display is also described along with its method of manufacture.

### REFERENCE TO TEXT, DRAWINGS AND IMAGES PLACED BEFORE THE CLAIMS

This application includes text, drawings and images immediately preceding the claims in the application, which material is incorporated herein by reference into the specification, and into the drawings to the extent such material includes images. The term Scrollcaster refers to a current product containing one or more features of apparatus and methods described herein.

### BACKGROUND

1. Field

This disclosure relates to display methods and devices that can be accessed and addressed wirelessly, including digital display devices, signs and other information sources and methods for accessing and addressing them wirelessly.

2. Related Art

Remotely addressable signs such as store signs, marketing signs, information signs and the like can be addressed or accessed electronically by handheld controls. Typically, the user approaches the sign and hits various buttons or enters various keystrokes that are used to access and/or change the display information. The user must be close enough that the signal from the handheld control can reach the sign. Additionally, the user typically confirms any changes or other operations on the sign visually before completing operation.

Restricted meaningful access to the sign for changes or other operations limits the applications for which the signs may be used. It also limits the user's ability to access the sign or make changes. For example, remote access to such signs is limited to line of sight or close physical proximity for accessing the sign or making changes wirelessly.

### SUMMARY

Methods and apparatus are described that provide a display and other information sources that can be addressed wirelessly, and in some cases even from anywhere in the world. Methods and apparatus are also described that make access to displays and other information sources easier, and that can make changing such displays and other information sources easier. In some examples, methods and apparatus are also described for an improved information or image display.

In one example of methods and apparatus disclosed herein, a display and methods for producing and operating the display include a wireless communications device, an interface and a display. In one example, the display is a digital display, and may include an LED display, an LCD display and/or other textual or graphical displays. The display can be an off-the-shelf display or one modified for a particular desired application. In the example of an off-the-shelf display, the interface may interpret and translate incoming messages for display on the display so that the messages can be understood and properly processed by the processor supporting the display. In the example of a modified display, the display can be modified to receive communications that can be understood, processed and produced on the display. In any of these examples, the wireless communications device can be a cellular communications device, and in one example a cellular modem.

In another example of methods and apparatus disclosed herein, a display and methods for producing and operating the display include a wireless communications device, interface and a display element. In one example, the wireless communications device includes a cellular modem, and in one example a cellular modem that can operate on any frequency used anywhere in the world. In one example, the cellular modem includes a GSM modem. The GSM modem may be configured to receive, operate with and output AT Commands, for example those including Hayes modem compatible commands. In other examples, the modem may be configured to operate with SMS messaging technology.

In an additional example of methods and apparatus disclosed herein, a display and methods for producing and operating the display include a wireless communication device, interface and a display element. In one example, the wireless communication device includes a conventional cellular SIM card. In one example, the SIM card is programmed to process messages, and in one example programmed to limit the number of saved messages. For example, the SIM card can be programmed to save only one message. In another example, the SIM card can be programmed to delete any sent messages once the messages are properly sent. In another example, the SIM card can be programmed to process an incoming message only if the incoming message includes a predefined character or character sequence or character set or combination. In another example, the SIM card can be programmed to delete previously saved messages when one or more new messages are properly received. For example, previously saved messages can be deleted on a first-in-first-out basis. In another example, previously saved messages are limited in quantity. For example, the number of previously saved messages can be limited to 5, 4 or even one. In the case of only one properly-received message being saved, a presently-saved message is replaced or written over by a subsequently received and properly processed message. Such program components as described herein can be implemented on wireless communication devices other than SIM cards.

In another example of methods and apparatus disclosed herein, a display and methods for producing and operating the display include a wireless communication device, interface and a display element. In one example, a wireless communication device can include a modem and a SIM card or other programmable communications device. A modem and/or SIM card, simply by way of example and not by way of limitation, can be programmed so as to automatically pass-through to the interface any proper messages. Alternatively, or additionally, a modem and/or SIM card can be programmed to send an outgoing message. In one example, such an outgoing message may be a confirmation of a properly received message. In another example, such an outgoing message may be a confirmation that a properly received message has also been properly displayed on the display element. In a further example, the wireless device can be configured to send an outgoing message to a particular recipient. In one example, the recipient may be a device at a predetermined cellular address, such as a cellular telephone number, a device at a predetermined network address such as a worldwide network address, or at another communications address. The recipient address may be previously stored in the wireless device or may be included in the content of the incoming properly-received message.

In an additional example of methods and apparatus disclosed herein, a display and methods for producing and operating the display include a wireless communication device, an interface and a display element. In one example, the interface may be a device for translating incoming messages to content that can be processed by the display element. In another example, the interface may be a device for converting incoming messages from the format corresponding to the incoming message string to a format to corresponding to the native language of a processor in the display.

In another example of methods and apparatus disclosed herein, methods and apparatus for producing and operating a display include a wireless communications device, an interface and a display element. In one example, the wireless device can be an off-the-shelf wireless device, for example one including a SIM card, and the device is then programmed to use AT commands. In another example, the device is programmed to pass an incoming message stream directly to the interface, for example without being otherwise processed by the wireless device. In an additional example, the SIM card can be programmed to receive an acknowledgment from the interface and send out a confirmation message to a designated address. The SIM card can be programmed to respond to the acknowledgment from the interface containing an AT command string. The SIM card can also be programmed to empty its “sent” folder or reduce the number of messages in the “sent” folder when the acknowledgment message has been properly sent.

In another example of methods and apparatus disclosed herein, methods and apparatus for producing and operating a display include a wireless communications device, an interface and a display element. In one example, the interface may be programmed or configured to receive an incoming message string from a modem, such as that for a wireless communications modem, and process the message string. The interface may be programmed to process an incoming message string to convert the message string to a form that can be understood and processed by a processor in the display element. The form of the resulting message for the display element may be one that is in a language native to the display element. The interface may be programmed to output the converted message string to the processor of the display element, as well as to receive a confirmation from the display processor indicating that the translated or converted message string has been properly presented or displayed on the display element. In another example, the interface may be programmed to produce an acknowledgment code, which may be a stored code or a code incorporating a content string recognizable by the wireless device or by a remotely-addressed communications device, which acknowledgment code can then be output to the wireless communications device for being sent to the remote address. In one example, the content string incorporated into the acknowledgment code may be an address of the wireless communications device (for example a cellular telephone number of a wireless communications device), a predetermined acknowledgment code (for example a Y), a copy of the message successfully displayed on the display device, or other content. Any of the wireless communications device, interface or display element can be programmed or configured to carry out an automatic shutdown and restart, or restart after an unexpected shutdown.

In examples of methods and apparatus for assembling and operating a portable communications device, for example a wireless communications device and for example a communications device incorporating a removable SIM card, the device may include a SIM card holder as to which the SIM card can be inserted and removed. The holder can be a sleeve, slot, frame or other structure for receiving and reliably holding while possibly also allowing removal of the SIM card. In one example, the holder includes a first face for permitting the SIM card to contact associated contacts in the adjacent electrical structures. The device includes a closure, cover or other structure for securing the holder in place for maintaining the SIM card electrical contact. The closure or other structure includes a shock absorption material or structure that reduces the impact of shock transmitted to the holder from an external shock. The shock absorption may be accomplished by a foam material, for example an open cell foam, a resilient biased material, for example a spring material, a cushion material, an impact resistant material, or the like.

In examples of methods and apparatus for display devices, a display device can be produced that may be substantially uniformly illuminated over substantially the entire surface of the display. In one example, the display device may be a planar or other multi-sided device. Additionally, in an example of a multi-sided device, several sides of the device can be illuminated from within the device and still be intelligible to a person viewing the display even when the information presented on the sides of the device are not mirror images of each other. In one example of a display device, an internally light-transmissive material can be illuminated by edge lighting. In another example of a display device, an internally light-transmissive material can have information applied to an external surface of the material, and in one example the information can be applied by screen printing, and in another example, the information can be applied by screen printing using flatbed printers, for example those used in conventional sign shops. In another example, an internally light-transmissive material can be modified for use as a display element by having one or more surfaces abraded, sandblasted, or otherwise similarly textured or treated to reduce the smoothness of the external surface. In an additional example of an internally light-transmissive material for use as a display element, at least one face of the material having a reduced smoothness can be printed for producing a display. Examples of light-transmissive materials include acrylic and Lexan (POLYCARBONATE RESIN), including optical grades of those materials.

These and other examples are set forth more fully below in conjunction with drawings, a brief description of which follows.

### BRIEF DESCRIPTION OF THE DRAWINGS

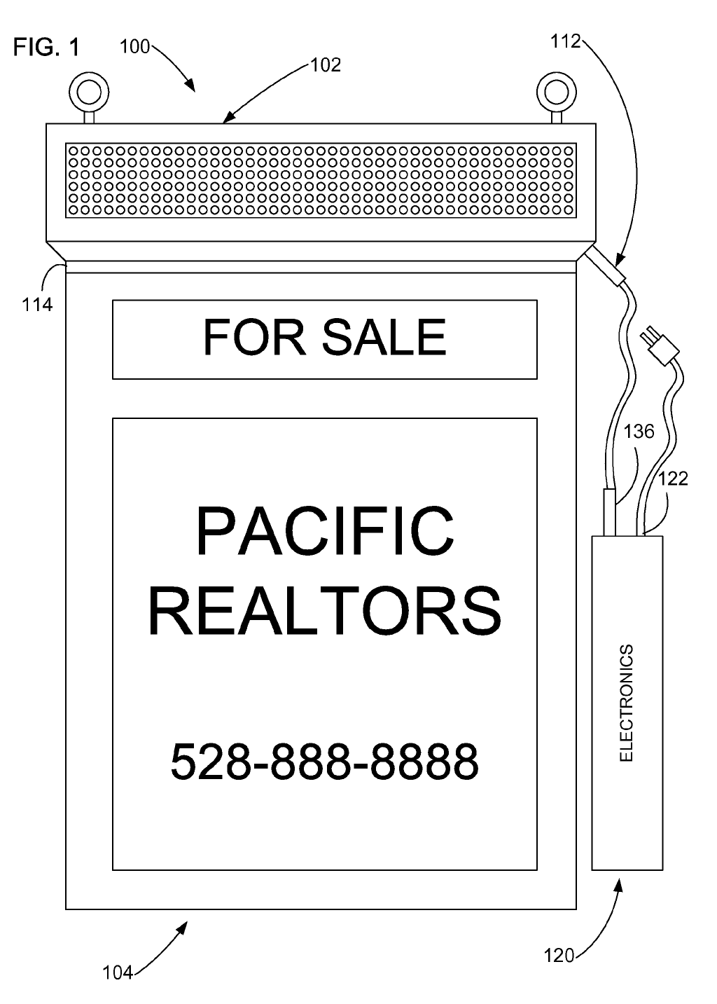

FIG. 1 is a side elevation view of one side of a display combination including a changeable display in the form of an LED display and an edge lit panel display, and a wireless modem and I/O unit.

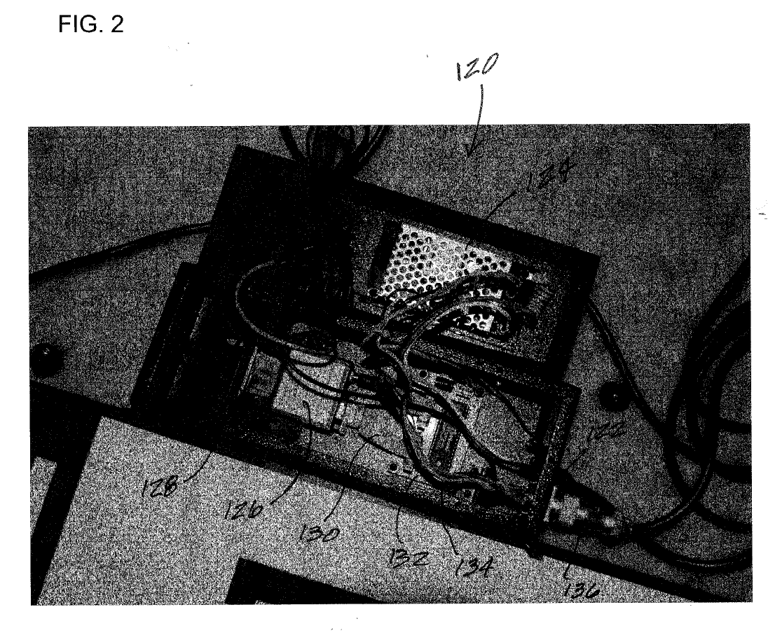

FIG. 2 is a top plan view of electronics for the wireless modem and I/O unit of FIG. 1.

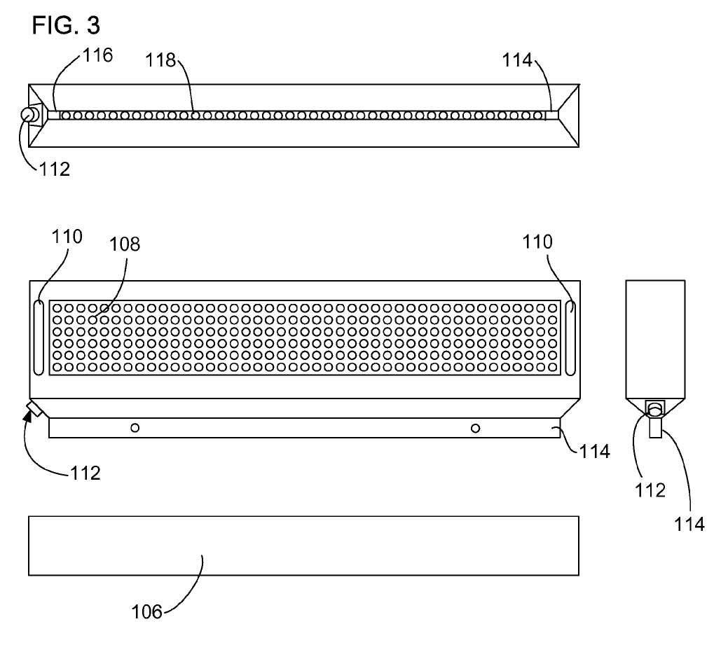

FIG. 3, from top to bottom and left to right, are bottom plan, front elevation, top plan and left side elevation views of a changeable LED display such as that for use with the combination of FIG. 1, and which has a two-sided LED display.

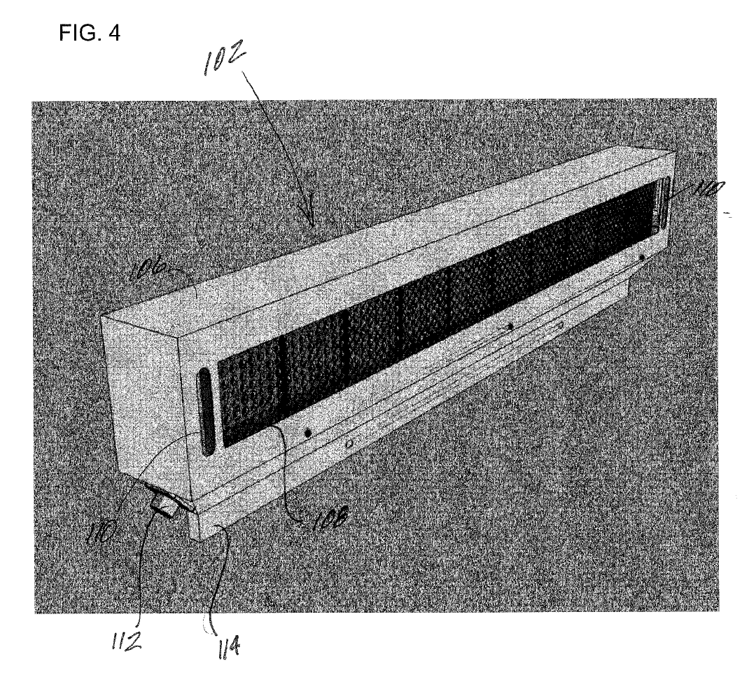

FIG. 4 is an upper left isometric view of the changeable LED display of FIG. 1.

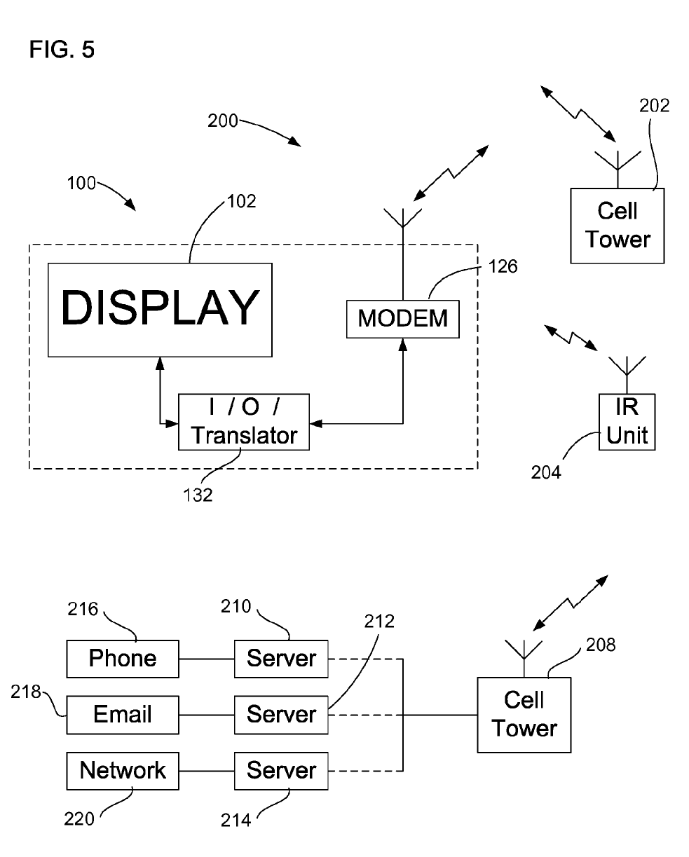

FIG. 5 is a schematic of a system incorporating a changeable display, for example one in which the display of FIG. 1 may be used.

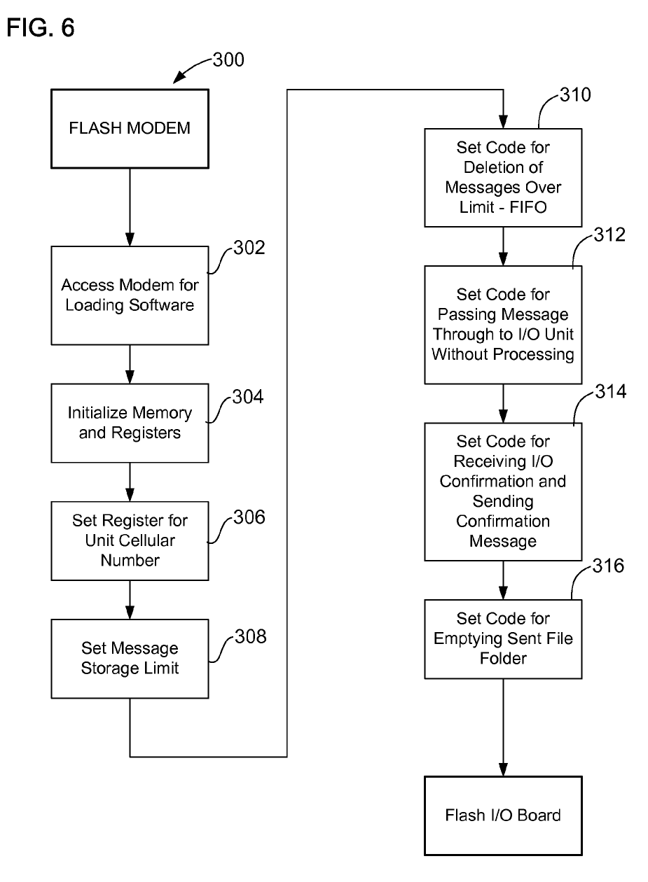

FIG. 6 is a flow chart representing steps that may be used to program a wireless communications card for use in the wireless modem in the combination of FIG. 1.

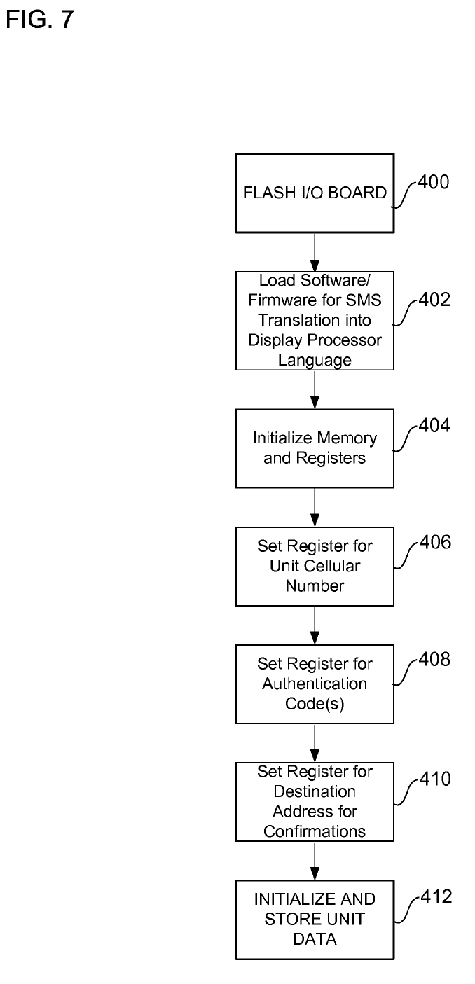

FIG. 7 is a flow chart representing steps that may be used to program an I/O or translator apparatus for use in the I/O unit in the combination of FIG. 1.

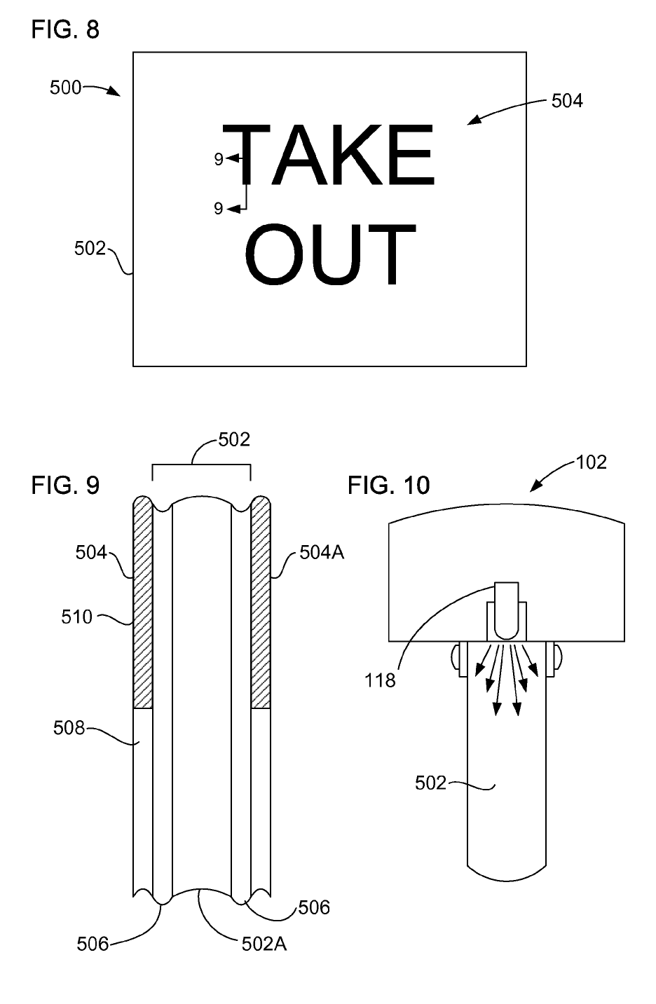

FIG. 8 is a schematic representation of an edge lit panel display such as one that may be used in the combination of FIG. 1.

FIG. 9 is a partial section of the display of FIG. 8 taken along line 9-9 and showing a light transmissive panel material whose face surfaces have been textured or treated to reduce the smoothness thereof and also showing outer layers of printing.

FIG. 10 is a schematic and partial sectional view of a lighting unit such as that combination shown in FIG. 1, in which an upper portion of a panel and a lower portion of a housing is shown with a light source adjacent an edge of the panel portion which has been edge mounted to the housing.

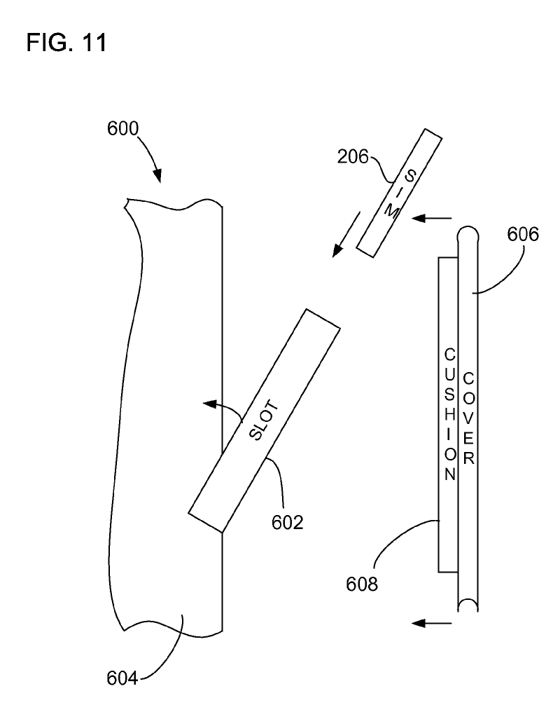

FIG. 11 is a schematic of a portion of a portable communications unit configured to receive a communications card and having a shock resistant support for the communications card.

### DETAILED DESCRIPTION

This specification taken in conjunction with the drawings sets forth examples of apparatus and methods incorporating one or more aspects of the present inventions in such a manner that any person skilled in the art can make and use the inventions. The examples provide the best modes contemplated for carrying out the inventions, although it should be understood that various modifications can be accomplished within the parameters of the present inventions.

Examples of displays and of methods of making and using the displays are described. Depending on what feature or features are incorporated in a given structure or a given method, benefits can be achieved in the structure or the method. For example, displays using wireless communications methods and apparatus may easier to use and have more uses than existing displays.

Additionally, some display configurations may also be more flexible in how they are accessed or changed for ongoing use.

Displays that use panels for presenting information may benefit also from one or more features described, for example both day and night-time use.

Improvements are also provided to the displays in which the components may be used. For example, communications cards such as SIM cards may made be more secure and reliable.

These and other benefits will become more apparent with consideration of the description of the examples herein. However, it should be understood that not all of the benefits or features discussed with respect to a particular example must be incorporated into a display, component or method in order to achieve one or more benefits contemplated by these examples. Additionally, it should be understood that features of the examples can be incorporated into a display, component or method to achieve some measure of a given benefit even though the benefit may not be optimal compared to other possible configurations. For example, one or more benefits may not be optimized for a given configuration in order to achieve cost reductions, efficiencies or for other reasons known to the person settling on a particular product configuration or method.

Examples of a number of display configurations and of methods of making and using the displays are described herein, and some have particular benefits in being used together. However, even though these apparatus and methods are considered together at this point, there is no requirement that they be combined, used together, or that one component or method be used with any other component or method, or combination. Additionally, it will be understood that a given component or method could be combined with other structures or methods not expressly discussed herein while still achieving desirable results.

LED lighted displays are used as examples of a display that can incorporate one or more of the features and derive some of the benefits described herein, and in particular retail signs. However, displays other than retail displays can benefit from one or more of the present inventions. Other examples include a wide variety of information and graphics presentations from highway signs, security and public place signs, to university logo and real estate graphics, as well as others.

It should be understood that terminology used for orientation, such as front, rear, side, left and right, upper and lower, and the like, are used herein merely for ease of understanding and reference, and are not used as exclusive terms for the structures being described and illustrated.

A changeable display assembly 100 (FIGS. 1 and 5) may incorporate one or more of the features disclosed herein. In the present example, the display assembly includes a changeable display unit 102 and a replaceable display structure 104 (FIG. 1). In the present example, the changeable display unit 102 is an electronic display such as an LED display described more fully herein, and a replaceable display structure 104 is an edge lit printed panel such as one also described more fully herein. In the present example, these two display elements are considered together in an assembly, but it should be understood that they can be used separately.

The housing for the changeable display and the replaceable display structure 104 can be modified to accommodate the support of other structures than panel displays, for example round, cylindrical, triangular or other shapes. However, a changeable display and replaceable display structure will be described in the context of a panel display structure. In the present example, the changeable display 102 is an LED display of suitable size, selected as a function of the desired application. Some examples are given in the Attachment immediately preceding the claims.

The changeable display 102 (FIGS. 1, and 3-4) includes a housing 106 for supporting and protecting the LED display array 108. In the examples shown in the drawings, one LED array 108 is shown for displaying information, but it is understood that a second LED array is positioned on a side of the housing opposite the array 108. Each of the front and back of the housing is substantially identical to the other. The front and back openings for the LED arrays are covered with respective translucent coated plastic panels to protect the LED display arrays. Slot openings 110 are formed in the front and rear portions of the housing to accept infrared signals from a handheld control unit, as is conventional for display signs changeable through an infrared handheld control unit. The infrared signals are received in the display processor assembled with the display array (not shown) for setting up and changing the display as desired, and as is conventional.

The top, sides and bottom of the housing are otherwise closed and preferably weatherproof. The housing includes a suitable electrical connector 112. The connector 112 allows access for power and communications lines to the changeable display unit. Power comes from a line input (not shown), which may come from a suitable power source, such as a utility line, a storage unit, a solar unit or other suitable supply. Power conductors can be passed through the modem and I/O unit described more fully below. The communications lines into the display unit are coupled to the I/O unit.

In the present examples, the housing also includes a panel support and edge lighting housing 114 (FIGS. 3-4). The panel support is a longitudinally extending rectangular cavity sized to receive the edge of the panel 104 and may include attachment elements such as pairs of holes for receiving fasteners, rivets or other fastening elements for securing the panel to the housing. The panel support defines an opening for receiving an edge of the panel up against one or more stop surfaces 116 so that the panel edge is adjacent an edge lighting light source 118, in the present example a linear LED array (FIG. 3). Other support configurations and other lighting configurations for the panel can be used.

In the present example, the display 102 is a weatherproof exterior and interior product that is suitable for multiple uses and industry applications. The lighting for a scrolling display is provided by LED (light emitting diode) technology that has a very long useful life (in many situations approximately 100,000 hours of use), and uses a small amount of power to operate. It is made to withstand hard use, impact, and wide temperature extremes (for example, −30F to 140F). The display includes a daylight-operation-capable, dual sided scrolling LED array display in red color mounted in a steel case, which may include a powder coated finish (not shown). A protective 3 mm polycarbonate protective window over each LED array is tinted to increase the contrast in daylight and to mute what may be an intense appearance during night use.

In the present example, the display 102 forms a scroller head unit that also has LED (118 in FIG. 3) down lighting built in that is channeled through the opening 114 (FIG. 3) through a relatively thin acrylic sheet, such as sign 104 in FIG. 1 (for example 7 mm or 6 mm, or also possibly Lexan), to provide a lighted, attached, internally-lit signboard. One example signboard, described more fully below, may be 24″×22″. The signboard can accept graphics printed on vinyl on both sides, or by using a milky finish translucent acrylic or Lexan board, the graphics can be flatbed-ink printed directly on the face of the acrylic signboard. The sign board may be also treated as described more fully herein.

In the present example, the modem apparatus and the I/O apparatus are housed in a single unit 120 (FIG. 2), though they can be separate for example in respective housings. The housing is also preferably weatherproof and suitable for outdoor use in most climates. The housing includes a power pass-through 122 for receiving power into the unit and to a power supply 124, configured to be a universal power supply capable of receiving any available input found with utilities, for example supplying nominally from 110 volts at 60 Hz to 240 volts at 50 Hz. The housing also includes an access for an antenna or other transceiver structure (not shown in FIG. 2) for allowing signals to pass through the housing. The antenna is coupled to a wireless modem 126, in the present example, which has a SIM card holder 128 for receiving a suitable SIM module. The wireless modem 126, as discussed more fully below, is configured in the present example as a GSM modem, and the SIM module is programmable, such as in the manner discussed herein.

The modem 126 includes a two way communications connection 130 to an I/O Board 132, also described more fully herein. The I/O Board in turn includes a communications connection 134 through a connector 136 coupled to the housing for communicating with the changeable display 102 through a suitable cable to the connector 112 (FIGS. 1 and 3-4). Other means for communicating between the I/O unit and the changeable display 102 can be used as well.

The changeable display assembly 100 (FIGS. 1 and 5) may be used as part of a subsystem. In the present example, the subsystem is a subsystem 200 (FIG. 5) that includes the changeable display assembly 100 and a cellular tower 202, where the changeable display assembly 100 is within acceptable transmission distance of the cellular tower 202. The subsystem 200 allows the changeable display assembly 100 to be used in conjunction with a cellular network so that a remote user can access the changeable display assembly. The purpose of accessing the changeable display assembly may be any one or more of the purposes or functions described herein, and may include changing the display 102, changing or updating software on any of the display 102, the modem 126 and/or the translator board 132, interrogating the changeable display assembly 100 for example to determine its status, or for other purposes.

The cellular tower 202 can be any conventional cellular tower. Alternatively, the cellular tower may be another communications transceiver within range of which the changeable display assembly 100 is placed. It is also possible that the communications device is a basic transmitter, for example without basic or significant receiver capabilities. However, in the examples described herein, the cellular tower 202 is a communications device or installation capable of accommodating GSM wireless communications, including GSM wireless communication to and from the modem 126.

The subsystem 200 may include, though it need not include, an infrared transmitter 204. The infrared transmitter 204 may be a conventional handheld transmitter unit typically accompanying wirelessly-controlled display units. The changeable display assembly 100 can be operated with the infrared transmitter 204 in the conventional fashion, communicating directly with the display 102 and bypassing the modem 126, but the present discussion of the subsystem 200 will be in the context of a subsystem having only the changeable display assembly 180 communications tower 202. However, it should be understood that other modes of accessing the changeable display unit 100 can be used, whether from a handheld infrared unit such as 204, a wired connection (not shown), or through other means.

The modem 126 in the present example (FIG. 5) is a GSM wireless communications device. In the present example, the modem includes the capability for receiving and transmitting signals at the four conventional frequencies (850 MHz, 900 MHz, 1800 MHz, and 1900 MHz), and possibly additional frequencies or other frequencies that may be used for remote communication. The four identified frequencies in the present example allow the adjustable display assembly to be operated anywhere in the world within transmission distance of a cellular tower 202 capable of operating with one or more of the conventional frequencies. The GSM modem is set to automatically select the correct frequency for sending and receiving communications signals. In the present examples described herein, the changeable display assembly can be addressed remotely by a cellular system wireless service, for example using SMS text messaging protocols, for example to allow changing a scrolling or static display message quickly and easily from anywhere in the world. The changeable display assembly can be addressed or accessed using a cellular telephone, a landline phone, Internet telephony, Internet messaging, other network communications modes, or by other means. Therefore, the changeable display assembly can be accessed and programmable remotely using wireless technology. For example, a message may be texted from a cellular phone or e-mail using a cell provider's proprietary e-mail-to-text server and gateway. (As noted above, the changeable display assembly can also be addressed at close range by using an infrared hand remote to change a message or other functions, including but not limited to on-off times, custom display graphics, as well as other features.) Other wireless communications technologies may be used in addition to or instead of the modes described herein.

In the present examples, the modem 126 is programmed and is configured to operate with well-known AT command sets, for example Hayes-compatible command sets. The AT commands are easily used for operating the modem and also for interacting with a SIM card to receive, process and output incoming messages. In the present examples, the modem 126 includes a SIM card, such as one used in conventional cellular telephones. A SIM card is represented schematically at 206 in FIG. 11. The SIM card will also include code representing its unique cellular telephone number or other address information unique for the card, so that the changeable display assembly can be accessed over the cellular or other communications network using the unique access information assigned to the modem as stored on the SIM card.

The GSM modem may also be programmed to store data in memory, as well. Stored information may include an answer back or call back address such as a telephone number or e-mail address to which confirmation messages are to be sent by the modem. The stored information may also include authentication or passcodes to uniquely identify the adjustable display assembly 100 for the destination to which the confirmation messages are to be sent by the modem. Other stored information may also be included.

In the present example, the GSM modem is programmed and configured to receive, process and also to send text messages according to the SMS text messaging protocol. While signals other than text messaging signals can be sent or received, with appropriate equipment and configurations, the present example is discussed in the context of text messaging. The modem is configured so that when an incoming SMS message is received, it can be immediately displayed on the display 102 (for example with an appropriately-configured translator 132). In the present example, the GSM modem is configured so that when a message is received, the message is not saved on the modem but is sent directly to the I/O Board through the serial port. Alternatively, any authentic incoming message can be saved until such time as a confirmation of successful display is received from the I/O Board, at which time the original message content (text displayed on the display) is transmitted back to the confirmation address or cell phone number stored on the modem. Thereafter, the incoming message, to the extent that it may remain in the modem, and the outgoing confirmation message is deleted or otherwise purged from the modem, for example so that no display messages remain on the modem. In the present example, incoming messages are forwarded to the I/O Board only if they include predetermined characters, code or other signals required by the GSM modem, such as may represent authentication code, pass code or other information serving to authenticate incoming messages as being properly addressed to the particular modem in the changeable display assembly 100. In the present example, the modem is configured to check for a prefix or other pre-code, including a password, appropriate AT control codes, as well as possibly a unique code applicable to all changeable display assemblies 100.

In addition to code or software stored in the modem for authenticating incoming messages, the modem is also programmed so that it does not save any incoming messages. Alternatively, the modem can be programmed so as to save only one or a limited number of incoming messages, and/or to save messages only before or only after an incoming message is output to the I/O Board. Therefore, one example can have the modem programmed to save no incoming messages, only one incoming message or only a limited number of incoming messages, for example only the three most recent incoming messages.

The modem is also programmed so that an authenticated message is automatically output from the modem to the I/O Board 132 over the connection 130. As noted, such incoming messages that are authenticated need not be saved in the modem received file, but are instead output to the I/O Board 132, or they can be saved, for example on the SIM card, only until such time as a confirmation message is sent out by the modem. The control of the SIM card for purposes of receiving, saving, processing and/or deleting messages can be done through the software/firmware saved on the modem.

Additional code is programmed into the modem to configure the modem to receive one or more instructions or messages from the I/O Board 132. For example, the modem can be programmed to receive a confirmation message from the I/O board indicating that the message was received properly. Additionally, or alternatively, the modem can be programmed to receive an I/O message indicating that a message has been properly displayed on the changeable display 102 (the displayed message typically being the message previously received from the modem). In one example, the I/O message can be a simple code indicating proper receipt and/or display of a message from the modem. The simple code can be a plurality of bytes or bits, or can be a code with more information. In another example, the I/O message can be a message string containing multiple segments of information. As described more fully below, the multiple segments may include information stored on the I/O Board. Stored information may include an answer back or call back address such as a telephone number or e-mail address to which confirmation messages are to be sent by the modem, for example if such information is not already stored on the modem. The stored information may also include authentication or passcodes to uniquely identify the adjustable display assembly 100 for the destination to which the confirmation messages are to be sent by the modem. Other stored information may also be included.

The I/O message, in addition to stored information, may include segments unique to that particular I/O message. For example, a segment may include a message number, for example a number or identifier next in a sequence of I/O messages sent by the modem. A segment may also include a copy of the message properly displayed on the changeable display. Other information may also be included in the segments.

The modem is also programmed to access the wireless network, such as a cellular network, for example to send outgoing messages from the changeable display assembly. In one example, an outgoing message may simply be a code or other symbol indicating continued proper functioning. In another example, an outgoing message may be used to indicate an error situation with the display assembly. In the present examples, an outgoing message will be a confirmation message indicating proper display of a message and also will include the content of the message properly displayed. In one example, the I/O message includes a destination address such as a cellular telephone number and the content of the message successfully displayed on the changeable display. The modem is programmed to use the cellular telephone number, strip the number from the outgoing message, access the cellular network with the destination address, and send the outgoing message containing the content of the message successfully displayed. In the present example of a GSM modem, the modem receives an AT command and the confirmation SMS message. The AT command initiates the GSM modem to send out the confirmation message to the confirmation cell phone. For example, if the original message came from a cellular telephone, the confirmation message is sent out to the same telephone number. If the original message came from an Internet address, e-mail communication or other source, a confirmation message is sent to a cellular telephone number that has been previously stored in the I/O board. Other destination addresses may be one found in the incoming message, a stored e-mail or text address, or other addressing information. Other actions can also be programmed into the modem.

The modem is also programmed to save the content of the message successfully displayed on the changeable display. For example, the message content can be saved in the sent file folder of the modem. The modem can also be programmed to delete a file from the sent file folder. For example, the modem can delete the oldest message in a sent file folder. The modem can also be programmed to save only a limited number of sent files in the sent file folder. For example, if the maximum number of files to be saved is one, the most recent outgoing message is saved and the immediately preceding outgoing message is deleted. In another example, if the maximum number of files to be saved is three, simply by way of example, the oldest sent file is deleted and the most recently-sent file is saved. Other saved file folder configurations can also be implemented on the modem.

The I/O board or translator Board 132 can take a number of configurations, as will be evident from the description herein. In one example, the I/O Board 132 includes a processor with appropriate memory for software or firmware, memory registers and other suitable components. The I/O board also includes input and output registers and buffers for receiving information from the modem and for receiving information from the changeable display, as well as sending information to the display and to the modem.

The I/O Board 132 is programmed with appropriate code to execute a number of processes. One function of the I/O board is to receive valid SMS text messages from the GSM modem, translate those messages into a message sequence that can be understood or interpreted by the changeable display 102, and to output the translated messages to the changeable display. In one example, the I/O Board processes and converts the incoming SMS formatted message to a format readable by the LED display. In one example, the readable format corresponds to a protocol format identified as SMS 1000 used by Factory 3.0 for its LED signs or displays. The converted message is then sent to a display controller in the changeable display. If other displays are used, the I/O Board is programmed or configured to convert incoming messages to messages that can be understood by such a display.

The I/O Board 132 may also be programmed to evaluate incoming messages from the modem to determine their authenticity. The processor on the I/O Board may compare a password in the incoming message string from the modem with a previously saved password or other code used for identification or authentication purposes. If the incoming SMS message cannot be authenticated, the message is ignored. If the incoming SMS message is validated, the SMS message is then processed, as described herein, and immediately output to the changeable display for display. Alternatively, all authentication steps can be carried out in the modem.

The I/O Board 132 is configured by coding or other programming to receive confirmation messages from the display. The confirmation message may be a simple code, a combination of information such as a simple code plus the original message being displayed, or other content. The I/O Board may also use International Mobile Equipment Identity (IMEI) or its equivalent for authenticating incoming messages or properly identifying destination addresses for outgoing messages.

In one example, the I/O Board 132 is configured or programmed so that the I/O Board receives an incoming SMS message and automatically saves the incoming message in memory. A processor compares a code segment or field in the incoming message to a password or other authentication code saved in memory to authenticate the incoming message. If the incoming message lacks any such code, or if the code is not recognized, the message is ignored without further processing. The I/O Board is also programmed to receive confirmation messages from the display processor indicating a successful display of the message or other content. If the I/O Board saves the incoming message from the modem, the I/O Board processor reads out the earlier incoming SMS message saved in memory, with any precursor characters stripped off or at that time strips off any authentication or pass code and sends the message with the destination address received from the modem, retrieved from memory or otherwise available to the processor. The I/O Board output message and other information is output to the GSM modem with an AT command to send an outgoing message to the destination address. The I/O board can be programmed for other functions as well. In another alternative, the I/O Board can output a confirmation code, and the modem can assemble a confirmation message directed to the confirmation destination, according to instructions and stored data on the modem. For example, the confirmation code from the I/O Board can include an AT or other command to the modem to assemble and send the outgoing command string. The outgoing string may include a segment for accessing the applicable network, the destination address and a confirmation message, which in this example includes the displayed message. Additionally, or alternatively, the modem can receive the confirmation and can assemble and/or use AT commands to the SIM card to assemble and send the outgoing command to string.

With the I/O Board or translator 132, the suitably-programmed changeable display 102 can remain unchanged from its factory issued configuration. As soon as a message is received from the I/O Board, the display controller places the message on the display. If the display is rendered successfully, the display controller returns a confirmation code to the I/O Board. It should also be understood that the display can be reconfigured to do additional processing of incoming messages, including all or part of the processing being done by the I/O Board 132, in appropriate situations.

The subsystem 200 can be part of a larger system constituting a wireless communications network, such as that represented schematically in FIG. 5. That network includes additional cellular towers, one of which is represented at 208. That as well as any other cellular towers in the network may be accessed by one or more servers, such as servers 210, 212 and 214, representing subsystems for interfacing between the network and source equipment and destination equipment. The servers may be network servers, telecommunications servers, terrestrial satellite communications equipment, as well as other equipment. The servers may interface with a number of devices or other equipment. In one example, a phone 216 may be used with the server 210 to send to and receive information from the cellular network. The phone 216 may be a cellular phone, a landline phone, a satellite phone or other communications device. In another example, a server such as server 212 depicted in FIG. 5 may be an interface for an e-mail system represented by e-mail device 218. In a further example, a server such as server 214 maybe an interface for other types of network devices 220 such as text messaging devices, Personal Digital Assistants (PDA) or other devices. Their servers can communicate with the particular cellular tower represented at 208 wirelessly, over land lines, by satellite or by other means. The subsystem 200 can also be made part of other or additional systems.

It will be evident from the description herein that the changeable sign assembly can be accessed remotely using a cellular communications network. Messages and/or display information can be sent to and received in the changeable display from anywhere in the world that can access the cellular communications network. Messages and/or display information can be received in the changeable display assembly and immediately displayed once the incoming message is authenticated and translated into a language or form that can be understood by the display processor. Various authentication or quality control measures may also be followed.

Methods of setting up and using the apparatus described herein can be implemented in a number of ways. In one example, the changeable display assembly can incorporate any conventional SIM card, such as one that can be purchased at any phone store. In the present examples, a SIM card compatible with the GSM modem technology is used and will be inserted into the changeable display assembly 200. The modem is programmed with instructions, including instructions to operate the SIM card, by flashing the modem 300 (FIG. 6). The modem is accessed 302 for loading the software, and the memory device and registers are initialized 304. A register is set 306 for the cellular telephone number corresponding to or assigned to the SIM card and/or a phone number or other address corresponding to a contact for confirmation messages to be sent or corresponding to other information or messages to be sent.

Code is also programmed into the SIM card to handle messages. A message storage limit is set 308 and program code is included 310 for deleting messages from a sent file folder. The SIM card is also programmed 312 for passing incoming messages through to the I/O board without processing in the SIM card. Additional code is included on the SIM card to permit the SIM card to receive the I/O confirmation messages 314 and send any confirmation messages to destination addresses, such as an address that may be stored on the I/O board. The SIM card is also programmed 316 for deleting message(s) from the sent folder of the SIM card.

The I/O board is also programmed 400 to carry out the desired functions (FIG. 7). The I/O board memory is flashed with software or firmware 402 to configure the I/O board to translate incoming SMS text from the SIM card to information or display data that can be processed by the display processor. Memory and registers are initialized 404 and registers are set 406 with a cellular telephone number of the changeable display assembly 100. A register may also be set 408 for storing one or more authentication codes for use in comparing with incoming messages for authenticating the messages. A register can be set 410 for receiving one or more destination addresses to which confirmation messages are to be sent. Thereafter, the modem and/or the SIM card and the I/O board can be programmed 412 with the desired information, including access or authentication codes, message length or message number limitations, reply address information as well as other desired information.

Once the changeable display assembly 100 is configured as desired, the LED display unit 102 can be tested, and a sign panel 104 attached and tested. The display assembly 100 is then mounted to a support structure such as a post, wall or other support structure for display. The infrared remote unit can be used to configure the display as desired. If the changeable display assembly is to be accessed through wireless communications, the assembly is placed in a location with acceptable cellular reception. If wireless communications methods other than the infrared handheld remote are to be used for setting up the assembly, a cell phone or other device can be used to set up and initialize the assembly.

The display structure 104 can take a number of configurations, including those described herein. In one example, the display structure 104 is a planar panel 500 formed from a transparent sheet material 502 such as optical quality acrylic, Lexan or other reliable materials (FIGS. 8-10). The panel will be mounted to the display 102 (FIG. 1) so as to permit the panel to be edge lit, for example using white LEDs, for example using the number shown in FIG. 3. The white LEDs are relatively high intensity white LEDs suitable for relatively uniformly illuminating the transparent sheet material 502. In the present example, the sheet material 502 is 8 mm acrylic. Information or display graphics is presented on the panel 500 for display. In the example shown for discussion herein, the information is text 504 printed onto the surface of the sheet material 502. In these examples, the sheet material can be printed with the information or display graphics. Additionally, information or display graphics can be printed on both sides of the sheet material so that the desired information can be seen from different directions, whether the information is the same on both sides or different. Where the information is different, in the present examples, the information on one side of the sheet material will not be visible from the other side of the sheet material. Image pass through from one side to the other may be minimized in several ways. For example, each surface to include text or other image material can be sand blasted, abraded or otherwise modified from its smooth or polished surface texture. In another example, the surface can be coated with a semi-transparent film as a background for the text or other image material. One or more edges of the sheet material may also be covered with a coat or film, or otherwise modified so that light is blocked from being emitted or is reflected from the edge. Black or other vinyl may be applied to the edge or edges.

The information or display graphics can be applied to the sheet material in a number of ways. In the present examples, the information or display graphics is applied through screen printing technology. In one example, high-quality semi-transparent ink is applied directly to clear, unprocessed surfaces on the sheet material. In another example, high-quality semi-transparent ink is applied to a processed or treated face of the sheet material. In this example, the sheet material will be considered to have a processed layer 506 (FIG. 9), on both sides of the sheet material in the present example shown in FIG. 9. In this example, the original sheet material is shown at 502A and the processed layers 506 are shown on opposite faces of the sheet material. In one example, the processed layers are sandblasted, and in another example they are abraded surfaces. It should be understood that the relative thicknesses of the processed layers 506 and the thickness of the sheet material 502A are not to scale. For example, a processed layer may be less than a millimeter thick where the overall thickness of the panel may be 7, 8 or 9 mm, in some examples. A processed layer may be formed in other ways, for example by application of a semi-transparent film, such as also by screen printing.

The text 504 (FIGS. 8-9) may be applied in a continuous film of material 508 with black or colored ink 510 forming the message information and clear or differently-transparent film applied elsewhere for contrast or background. Alternatively, where a background may be a darker background, the outer layer/layers can include a combination of inks and vinyl sheet overlays. In a further alternative, no film or graphic information is applied where no information is to be placed and where no material with light-changing properties is desired. In other examples, conventional and/or high-quality semi-transparent ink is applied to a clear, unmodified surface to form the information or graphical presentation desired, or conventional and/or high-quality semi-transparent ink is applied to a processed surface, such as one of those described herein.

In the modem, the SIM card 206 in the modem structure 600 (FIG. 11) may be supported in a receiver and support slot 602. The receiver and support slot 602 may be identical or similar to a conventional SIM card receiver supported in the modem structure 604 so as to ensure suitable electrical contact between the SIM card and contacts in the modem electronics. The SIM card and the receiver and slot are covered with a cover 606 in a manner similar to the assembly of conventional covers on cell phones.

In the present example, a cushion 608 is provided between the cover and the SIM card slot and receiver to more securely support the SIM card. The cushion may be an impact resistant material, and in one example a foam, and may be an open cell foam. Other materials may be used as alternatives.

In the present example, the cushion 608 has a surface area that is at least coextensive with the surface area of the SIM card. In another example, the cushion extends beyond one or more of the boundaries of the perimeter of the SIM card.

As is apparent, the GSM 4 frequency (850 mhz, 900 mhz, 1800 mhz, 1900 mhz) modem can be used to accept a conventional wireless service provider's SIM card (prepaid typically). The frequencies installed in the GSM modem allow the changeable display to operate anywhere in the world. This configuration allows the sign to be addressed remotely via cell system wireless service (SMS text messaging protocol) so that a message, for example a scrolling message, can be changed quickly and easily from anywhere. The message may be texted from a cell phone or emailed via the cell provider's proprietary email-to-text server and gateway. The changeable display also is addressable at close range by using the infrared hand remote to change the message and particular functions of the sign (on-off times, custom display graphics, etc). The changeable display in one example is designed to give a message change confirmation for any wireless remotely addressed message change. If a message is changed via a cell phone text, the confirmation is returned to whatever cell phone number it originated from. The confirmation shows the exact message that was received and displayed. If a scrolling message is addressed to the sign by email, the changeable display has a programming function that allows a user to send it a text message with a prefixed code so that the emailed message confirmation can be seen on whatever cell phone number is chosen to receive it. Once that cell number is elected, it only changes when the user programs in a new one.

By using email to address a sign(s), multiple signs can de changed simultaneously (same message change on all signs) by forming email groups, selecting the group, and sending to the message to all at once. Each will respond with a return text message of the change to the chosen programmed cell phone number with a confirmation. If no confirmation is required, a user may program in a cell number of 000 0000000, for example.

The GSM modem may be set to automatically select the correct frequency to send and receive on. The changeable display is built with a universal power supply that accepts any available input from 110v 60 cycle to 240v 50 cycle.

A separate I/O board makes the changeable display more reliable and universal: the I/O board (input-output) is fitted between the GSM and the scrolling display controller so that the standard output language can be translated by a program flashed on the I/O board into the native input language of the controller.

The use of GSM SMS system that has a SIM card allows messages to be routed via the inexpensive prepaid cell service provider's system. Texting, for example, has a low power/signal requirement, is fast and easy, and inexpensive.

The changeable display can be designed and built in a modular way that allows easy and quick servicing by unplugging any component and removing it for repair or replacement. Also, the LED scrolling display lighting units can be made interchangeable. In one example, the changeable display is initially fitted with 8×80 pitch (8 points of light high by 80 points wide) display cards, which is suitable for English characters and many other languages. If Asian characters, Middle Eastern or other more complex characters are going to be displayed, the display is fitted with 16×160 LED display cards fit into the same space but the ‘pitch’ is higher and therefore the complex characters can display properly. The controller is already preprogrammed with all language display software capability, which is selectable and changeable by using the IR remote (more complex functions reside at that input so that wireless messaging is not overly complicated).

The changeable display can be designed to be lightweight so that it can be easily suspended. The additional components to run it are mounted in a separate weatherproof equipment box. The UL listed power supply is also contained in the equipment box to avoid heat and crowding in the scroller head. The scroller head and the equipment box are both well ventilated with weatherproof input air supplies and exhaust fans.

Having thus described several exemplary implementations, it will be apparent that various alterations and modifications can be made without departing from the concepts discussed herein. Such alterations and modifications, though not expressly described above, are nonetheless intended and implied to be within the spirit and scope of the inventions. Accordingly, the foregoing description is intended to be illustrative only.

1. A text, graphical display or information display comprising:
a wireless communications device configured to operate with AT commands, a display, and an interface between the communications device and the display.

2. The display of claim 1 wherein the wireless communications device is a modem.

3. The display of claim 1 wherein the wireless communications device is configured to operate at any one of a plurality of frequencies.

4. The display of claim 3 wherein the plurality of frequencies include 850, 900, 1800 and 1900 MHz.

5. The display of claim 1 wherein the wireless communications device is a GSM modem.

6. The display of claim 1 wherein the wireless communications device is configured to process messages in accordance with SMS messaging technology.

7. The display of claim 1 wherein the wireless communications device is configured to receive messages, at least temporarily store one or more messages, and to limit the number of stored messages.

8. The display of claim 7 wherein the wireless communications device is configured to delete stored messages.

9. The display of claim 1 wherein the wireless communications device is configured to output messages to the interface only if the communications device receives an incoming message having a proper pass code.

10. The display of claim 1 further including a subscriber identity module.

11. An information or graphical display comprising a wireless communications device having a modem and a subscriber identity module, a display element and an interface between the display element and the communications device and where in the wireless communications device is configured to send a message to a recipient external of the display once the wireless communications device receives a confirmation that the display is displaying properly.

12. The display of claim 11 wherein the wireless communications device is configured to delete information from the wireless communications device upon receipt of a confirmation that information is properly displayed on the display element.

13. A portable wireless communications device comprising a transceiver, a processor for processing incoming messages and outgoing messages, a removable identity module electronically coupled to the processor, and a holder for the removable identity module and a resiliently flexible element for helping to hold the identity module electrically coupled to the processor.

14. The device of claim 13 wherein the resiliently flexible element includes a foam.

15. The device of claim 13 further including a cover and wherein the resiliently flexible element is positioned on the cover.

16. The device of claim 15 wherein the flexible element extends to be at least coextensive in surface area with the identity module.

17. A display element comprising a light-transmissive element having first and second surfaces extending to an edge surface, wherein at least one of the first and second surfaces includes visible information formed thereon and a light source positioned relative to the light-transmissive element so as to direct light at the edge surface.

18. The display element of claim 17 wherein the light-transmissive element is substantially planar.

19. The display element of claim 17 wherein the surface including visible information includes ink applied to a substantially flat surface.

20. The display element of claim 17 wherein the surface including visible information has a reduced clarity.

21. The display element of claim 20 wherein the reduced clarity is produced by sandblasting surface.

22. The display element of claim 20 wherein the reduced clarity is produced by abrading.

23. The display element of claim 17 wherein the visible information is applied to the light-transmissive element by screenprinting.

24. The display element of claim 17 wherein the light-transmissive element is formed from acrylic.

25. A method of producing a display element comprising:
connecting a display element with a wireless communications device having a subscriber identity module; and
configuring the wireless communications device to operate with AT communications commands.

26. The method of claim 25 further including configuring the wireless communications device to receive messages conforming to an SMS messaging technology.

27. The method of claim 25 further including configuring the wireless communications device to evaluate an incoming message for an acceptable pass code.

28. The method of claim 27 further including configuring the wireless communications device to forward the incoming message without the acceptable pass code to the display element.

29. The method of claim 28 further including configuring an interface element between the wireless communications device and the display element to modify the incoming message from the wireless communications device before transmitting the message to the display element.

30. The method of claim 29 further including configuring the interface element to modify the incoming message from the wireless communications device to a language native to the display element.

31. The method of claim 28 further including configuring the wireless communications device to output a confirmation message when a confirmation message is received from the display element.

32. The method of claim 31 further including configuring an interface element between the wireless communications device and the display element to produce a confirmation code when a message is properly displayed on the display element.
